(19) United States
(12) Patent Application Publication
(10) Pub. No.: US 2004/0243636 A1
(43) Pub. Date: Dec. 2, 2004

(54) Equipment health monitoring architecture for fleets of assets

(75) Inventors: Joe Hasiewicz, Glen Ellyn, IL (US); James P. Herzog, Downers Grove, IL (US); Richard C. Marcell, Naperville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: SMARTSIGNAL CORPORATION

(21) Appl. No.: 10/802,251

(22) Filed: Mar. 17, 2004

Related U.S. Application Data
(60) Provisional application No. 60/455,812, filed on Mar. 18, 2003.

(51) Int. Cl. G06F 7/00

(52) U.S. Cl. 707/104.1

(57) ABSTRACT

A system and method for use in monitoring equipment condition employs an empirical model, a rules engine, incident generation and resolution logic, a display interface, and a messaging capability for interacting with other systems. The empirical model uses similarity-based modeling to generate equipment instantiation-specific models with high fidelity. Residuals are generated by comparison of model estimates with actual current parameters, and rules are used to identify diagnostic incidents from patterns in the residuals, actual values, estimates, and alerts on residuals.

### BACKGROUND OF THE INVENTION

The present invention relates to an equipment health monitoring system and method, and more particularly to an architecture facilitating predictive maintenance for fleets of assets such as aircraft, ground-based vehicles, combustion turbines, locomotives, and the like.

It is known to monitor the health of an asset or a subcomponent of an asset (such as the propulsion units of an aircraft) by instrumenting it with sensors and monitoring the sensor readings to detect signs of failure. Typically, sensor values are compared to allowable ranges, and when a threshold is breached by a sensor value, this is indicative of a developing problem. It is further known to use a variety of techniques to generate estimates for the sensors to compare to the actual sensor values in order to determine anomalies. Models can be used of equipment performance or operation to generate such estimates. By way of example, a physics-based model of an asset, such as a jet engine, may generate estimates of temperatures and pressures within the engine in response to inputting of control settings and environmental variables such as speed, altitude, ambient temperature, etc.

It has been a practice in the prior art to build such sensor thresholds and model-based anomaly detection into components of assets and asset platforms, i.e., onboard. For example, in aviation, many subsystems of an airplane incorporate “built-in tests” or BITs, which generate alerts or maintenance action messages when a fault is indicated. Typically, these are brought to the attention of the operator of the asset, e.g. a pilot in the case of an aircraft, or a plant operator in the case of a ground-based combustion turbine. Alternatively, these indications may be brought to the attention of a maintenance worker, as for example when an aircraft lands and is brought to hangar for maintenance, where a maintenance worker may download BIT results over a computer link or personal digital assistant (PDA).

More recently, operators of fleets of assets have begun to concentrate maintenance and diagnostic know-how into a geographically centralized facility. Sensor data from far-flung or mobile assets is transmitted via a variety of network means (wireless, cellular, landline) to this diagnostic center for analysis by these experts, who can then issue work orders for maintaining the assets in a more economical and anticipatory fashion. It is known, for example, to capture and store in a central database in such a facility the raw sensor data from jet engines across an air carrier's fleet. Unfortunately, these experts lack tools to efficiently analyze these now-tremendous data volumes. While manufacturers of asset subsystems and assets often provide diagnostic software for monitoring of their manufactured products, the fleet operator may operate assets manufactured by a variety of vendors, and must use a variety of tools to do fleetwide analysis. There remains a need for fleet-centric monitoring using a common exception-based, model-based monitoring tool.

In addition, diagnostics provided by manufacturers often are based on disparate monitoring techniques that are highly specialized to equipment make. This increases the burden on the expert's time in creating and managing monitoring models and rules using a variety of specialized methods. What is needed is a common modeling and monitoring approach that can be learned once and applied to a variety of assets and asset subsystems.

### SUMMARY OF THE INVENTION

The present invention relates to an equipment health monitoring architecture enabling predictive maintenance of fleets of assets such as aircraft jet engines, using real-time or near real-time data from multiple sensors from the assets. The invention provides a common software platform for viewing fleetwide exception-based asset health. Accordingly, a modeling method is provided that can be applied effectively to a wide variety of equipment, components, and asset platforms, and this is coupled with an incident management logic engine for registration and management of asset-focused incidents. A presentation module provides an exception-based “watchlist” view of incidents, thereby giving equipment health analysts an efficient tool for management of asset fleet health and availability.

The invention can be employed in software in a centralized monitoring and diagnostic center, for enterprise-wide coordinated management and maintenance of a fleet of assets. A module is provided for creating models of assets and initiating monitoring. Incident logic provides notification functionality for asset incidents, via email, pager and the like, thereby allowing coordination of maintenance actions by analysts in the diagnostic center with workers remotely located with the assets.

### BRIEF DESCRIPTION OF THE DRAWINGS

The novel features believed characteristic of the invention are set forth in the appended claims. The invention itself, however, as well as the preferred mode of use, further objectives and advantages thereof, is best understood by reference to the following detailed description of the embodiments in conjunction with the accompanying drawing, wherein:

FIG. 1 is a block diagram of the system of the present invention;

FIG. 2 shows a flowchart of steps for implementing monitoring according to the invention;

FIG. 3 illustrates a rule object for use in diagnostics of an incident according to the present invention; and

FIG. 4 illustrates a data hierarchy for use in a preferred embodiment of the present invention.

### DETAILED DESCRIPTION OF PREFERRED EMBODIMENTS

The present invention provides robust, highly sensitive fault detection architecture for monitoring of the equipment health of equipment such as aircraft jet engines and the like. The architecture is built around a data driven modeling engine that can generate a sensitive model for each specific engine that is monitored. Historic data from an engine in its normal operating condition is used to build a model of normal operation, and this model is then used to generate estimates of what current engine operation parameters should be in response to receiving real-time or near real-time data from the currently monitored engine. The estimates are compared to the actual current measured values to produce residual signals, indicating the difference between actual values and modeled predictions. Deviations are indicated within the architecture of the monitoring system both to display and to a fault recognition and characterization module which can diagnose a condition in the equipment indicated by the residuals, or the residuals in combination with raw data values or other state values for the current engine state. A sophisticated rules engine is employed to translate sets of conditions indicated by residuals, raw data and state variables into known incident types, which are used to drive the display of a watchlist of highly suspect items for a given engine. A resolution module provides actions to resolve the incidents on the watchlist.

The architecture of the present invention is deployable for monitoring not merely of individual jet engines and the like, but for fleets of such equipment, and thus can be used efficiently in an analyst center located geographically distant from the monitored equipment, where human analysts can investigate incidents on the watchlist for a variety of engines or other equipment. Using the present invention, a small number of highly trained experts can efficiently monitor a large fleet of equipment assets such as jet engines across a commercial fleet of aircraft, to predict which assets should be diverted to maintenance centers during lulls in operation for cost effective maintenance and overall increase in availability of the assets.

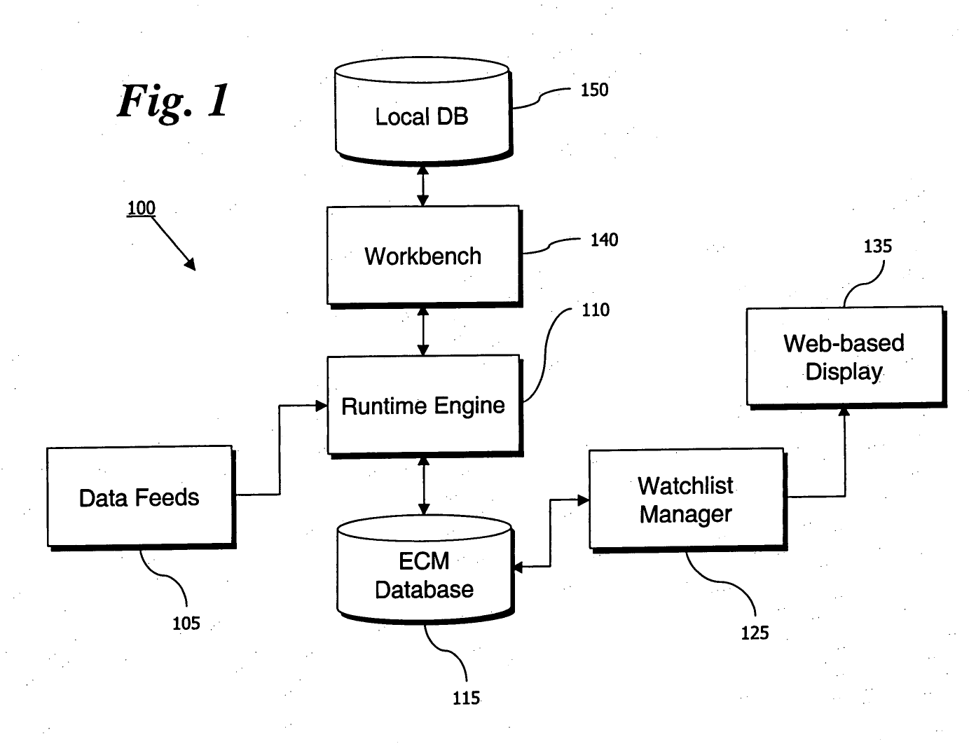

Turning to FIG. 1, the architecture of the system 100 of the present invention is shown to have a data feeds module 105, that comprises one or more data input and decoding techniques, for receiving sensor data from a piece of equipment in a variety of formats. For example, data may be polled from another database on a network, which spools data from sensor hardware in real-time. Alternatively, data may be pushed as packets or messages that arrive synchronously or asynchronously over a network at the data feed 105, and must have messaging information stripped off in order to get at the sensor data carried inside the packet. The data feed 105 provides the raw data (current observation) to a runtime engine 110, which can store the raw data to the equipment condition monitoring database 115. The ECM database 115 also contains preexisting models of each equipment asset that is monitored. In response to receiving one or more current observations, where an observation comprises time-correlated or synchronous data readings from all the sensors that serve as inputs to the modeling, the runtime engine 110 calls up the model corresponding to that asset from the ECM database 115, and generates estimates for parameters of the asset for comparison to the raw values. The comparison generates residuals, representing the difference between the estimated values and the actual values for each modeled sensor or parameter. The estimates and residuals may also be stored in the ECM database. The runtime engine 110 then executes alert generation and incident identification rules against the raw data, the estimates, and the residuals, and combinations thereof, to identify any applicable incidents about the equipment asset. The incidents are also stored to the ECM database. A watchlist manager 125 serves as a presentation layer for extracting information from the ECM database and building presentation screens that can be viewed in the web-based display 135. A workbench module 140 is used to first generate empirical models based on historic data, and can be used either online with the runtime engine and ECM database, or can be used offline, disconnected from them. The workbench module downloads the current models (if any), and necessary historic data from the ECM database, and stores it locally in a local database 150. When model building or refining is completed with the workbench module, the new or refined models can be reinserted into the ECM database by connecting to the runtime engine and ECM database. Thus, the workbench module is not intended for online monitoring, but rather to setup the system, build models, and test new configurations.

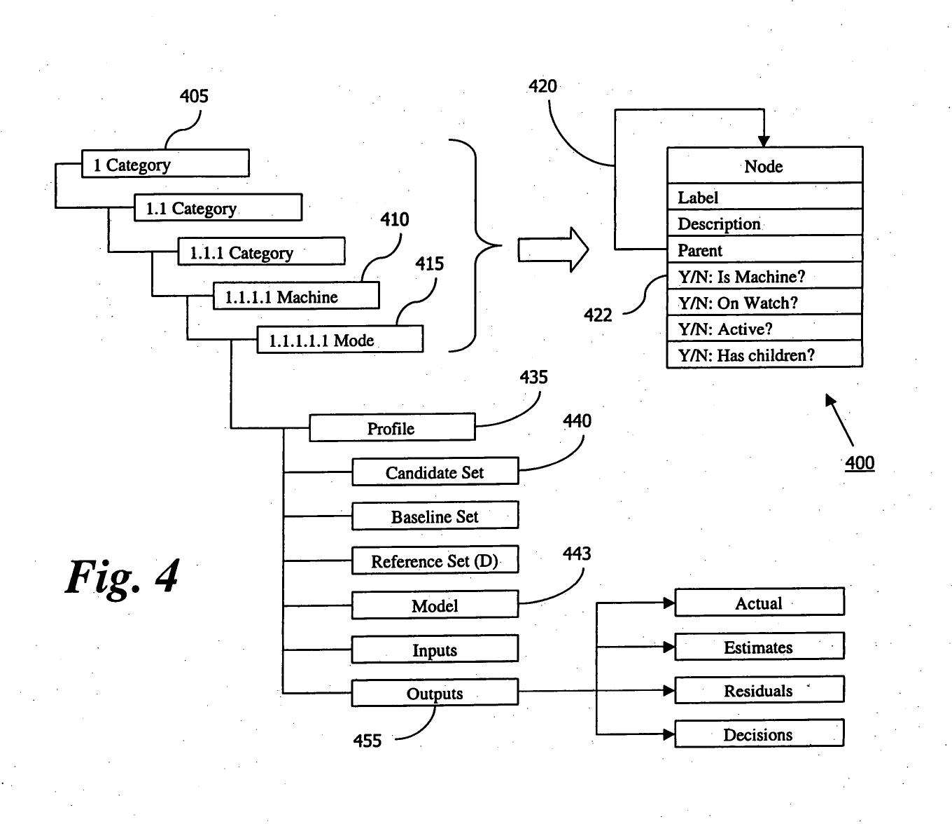

Because the present invention is intended to be capable of use with not just single pieces of equipment, but also fleets of similar or dissimilar assets, the data architecture for storage of the models is hierarchical, as shown in FIG. 4. The main element of the hierarchy is the node 400, which can be a category 405 or a machine 410, i.e., piece of monitored equipment, or a mode of operation 415 of an equipment asset. Each node 400 is located in a nested hierarchy by virtue of the parent-to-child link 420. The location of the actual machine that is monitored within the hierarchy can be determined by a flag 422 in a given node. Within each mode 415, the modeling specifics can be stored. A mode can be modeled by more than one model, and so a profile 435 is used to designate the combination of sensors that comprise that particular view and model of the mode and machine. The profile 435 can store such specific data items as the candidate set 440 of historical data from which a model is built, the model 443 itself that is used to monitor the asset in that mode, and links to all the outputs 455 that are generated by that profile model, including the estimates, the residuals, and any alert decisions or incident diagnoses made based thereon, as well as a pass through of the raw actual data values from current observations. All of this is stored in this hierarchical fashion to facilitate efficient monitoring of fleets of equipment assets, such as jet engines.

The modeling engine within the runtime engine in the present invention can comprise any data driven modeling technique capable of generating estimates in response to the receipt of a “current” or “of interest” observation of data values from the equipment being monitored, based on learning from historic data characterizing normal operation. More particularly, the modeling engine preferably uses a nonparametric data driven technique, which for purposes of this invention means a data driven technique in which the modeling parameters for generating sensor estimates are not fixed, but rather re-determined on the fly with each new observation from an asset. Kernel-based methods are nonparametric methods that may be used according to the invention, such as kernel regressions and similarity-based modeling, where a function, or “kernel”, is used to combine learned observations in a weighted fashion based on the input observation to generate model results. In general, these techniques are most generalizable for modeling fleets of assets and asset subsystems, and provide for purely data-driven modeling which avoids an investment in first-principles modeling and in tuning parametric estimators (such as neural networks), and provides for novel residual and alert precursors of failures for diagnostic purposes.

A suitable kernel-based non-parametric model for use in the present invention is generally described by the equation:

\vec{Y}_{estimated}=\overline{C}·\vec{K}(\vec{X}ᵢₙ,\overline{D}) (1)

where estimated sensor readings Y_{estimated} are determined from the results of the kernel function K operating on the input observation vector Xᵢₙ and the set of learned observations in D, weighted according to some weight matrix C. In an alternative form, the kernel responses can be normalized to account for non-normalized data:

$${\vec{Y}}_{estimated} = \overline{C} \cdot \frac{\vec{K} ( {\vec{X}}_{in} , \overline{D} )}{M} \qquad ( 2 )$$

where M is some normalization factor.

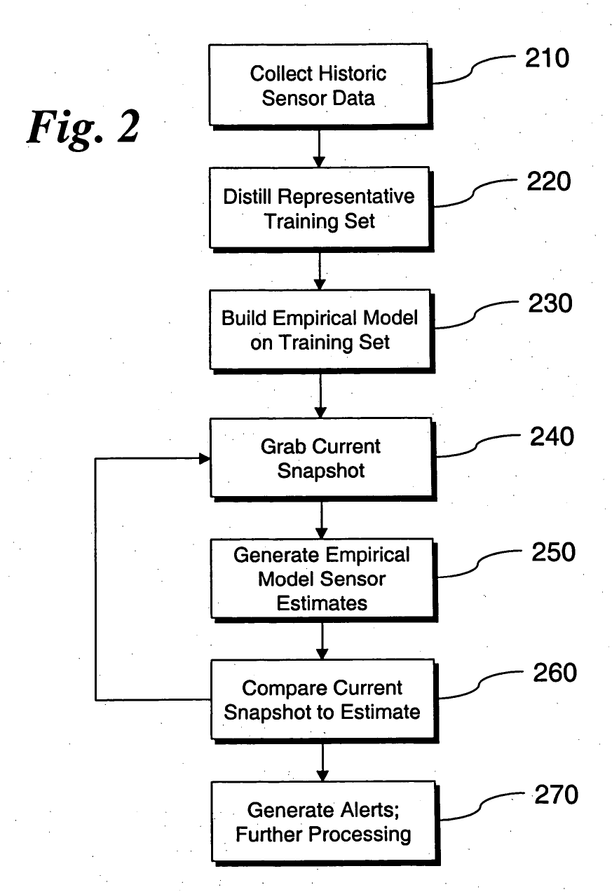

In a most preferred embodiment of the present invention, a similarity-based modeling approach is used. Accordingly, historic data acquired during operation of the asset that was deemed to be operating normally is automatically processed to produce a subset of observations that characterize normal operation, in a training process. This subset of data is then used in similarity-based modeling. Turning to FIG. 2, the process of implementing and then running the modeling engine can be seen more specifically. In step 210, historic data is collected from a variety of sensors and even state variables of the equipment to be monitored, while in a normal operational state, and furthermore throughout normal operational states that span the reasonably expected ranges of operation of the equipment. The data preferably comprises “snapshots” of time-correlated or synchronous data from all the sensors and state variables of interest. In step 220, this set of collected data is distilled down to subset of observations that properly characterize the normal operation of the equipment. In a preferred embodiment, the subset can comprise each and every observation that contains either a minimum or a maximum value for a given sensor throughout the historic data set from step 210. Hence, if there are n sensors that will be used in the model, there will be a maximum of 2n observations in the distilled data set. This distilled set can be augmented further with a selection of additional observations from the historic set, either randomly, or according to some method for picking reasonably spaced observations in n-dimensional space.

In step 230, the empirical similarity-based model is built from the distilled observations. This can be done in the preferred embodiment by precalculating a matrix G, according to:

$${\overline{G}}^{- 1} = {( {\overline{D}}^{T} ⊗ \overline{D} )}^{- 1} \qquad ( 3 )$$

where D is a matrix comprised of the distilled observations, arranged so that each column of D is a selected observation, and each row of D corresponds to a particular sensor. The similarity operator is represented above by the symbol \mathring{×}, and can be chosen from a number of available similarity operators, all of which have the property of comparing a row of the first operand to a column of the second operand to yield a measure of similarity between the two, and does for each such row and column combination in the operands. By way of example, one similarity operator that can be used compares the two observations (the ith row and jth column) on an element-by-element basis. Only corresponding elements are compared, e.g., element (i,m) with element (m,j) but not element (i,m) with element (n,j). For each such comparison, the similarity is equal to the absolute value of the smaller of the two values divided by the larger of the two values. Hence, if the values are identical, the similarity is equal to one, and if the values are grossly unequal, the similarity approaches zero. When all the elemental similarities are computed, the overall similarity of the two observations is equal to the average of the elemental similarities. A different statistical combination of the elemental similarities can also be used in place of averaging, e.g., median.

Generally, a similarity operator follows these guidelines:

1. Similarity is a scalar range, bounded at each end.

2. The similarity of two identical inputs is the value of one of the bounded ends.

3. The absolute value of the similarity increases as the two inputs approach being identical.

Accordingly, for example, an effective similarity operator for use in the present invention can generate a similarity of ten (10) when the inputs are identical, and a similarity that diminishes toward zero as the inputs become more different. Alternatively, a bias or translation can be used, so that the similarity is 12 for identical inputs, and diminishes toward 2 as the inputs become more different. Further, a scaling can be used, so that the similarity is 100 for identical inputs, and diminishes toward zero with increasing difference. Moreover, the scaling factor can also be a negative number, so that the similarity for identical inputs is −100 and approaches zero from the negative side with increasing difference of the inputs. The similarity can be rendered for the elements of two vectors being compared, and summed or otherwise statistically combined to yield an overall vector-to-vector similarity, or the similarity operator can operate on the vectors themselves (as in Euclidean distance).

In a preferred embodiment of the invention, a similarity operator is used that calculates the similarity of two observations comprising N sensors as:

$$sim = \frac{1}{N} {\sum }_{i = 1}^{N} \frac{1}{[ 1 + \frac{{θ}_{i}^{λ}}{C} ]} \qquad ( 4 )$$

where θᵢ is the relative difference for sensor i of observation X and observation Y, (i.e., θᵢ=|Xᵢ−Yᵢ|/Rᵢ). The Range vector (R) is the anticipated variation for each of the sensors in the model.

Once the G matrix has been calculated in step 230, it can be stored for use in monitoring. In an alternative embodiment, the observations comprising the D matrix can be stored, and in monitoring mode, the current observation of sensor data from an asset can be used to “localize” on a subset of observations in D. This subset then comprises a new localized D matrix and a G matrix is computed for the current observation. In this embodiment, step 230 follows step 240 and is part of the iterative monitoring loop from 260 to 240. Localized selection of a subset of D observations can be achieved using a variety of approaches, including using a similarity measurement such as equation 2 above between the current observation and each observation in D, and using those D observations for which the similarity is above some threshold.

Continuing with FIG. 2, in step 240 the current observation is obtained from the monitored equipment, comprising a time-correlated or synchronous snapshot of the values of the same sensors that are used to build the G matrix. In step 250, the current observation is used in conjunction with the G matrix of step 230 to model the equipment and generate estimates for sensors. In a first mode of the invention, the autoassociative mode, a sensor estimate is made for every sensor that is part of the current observation. Accordingly, the estimate observation, comprising the estimates for each sensor, is provided by:

\vec{Y}_{estimated}=\vec{D}∘\vec{W} (5)

where the weighting vector W is defined by:

$$\begin{matrix}\vec{W} = \frac{{\hat{W}}_{\to }}{( {\sum }_{j = 1}^{N} \hat{W} ( j ) )} & ( 6 ) \\ {\hat{W}}_{\to } = {G}^{- 1} ∘ ( {\overline{D}}^{T} ⊗ {\vec{Y}}_{in} ) & ( 7 )\end{matrix}$$

and Yᵢₙ is the input observation. Rewritten in terms of equation 2, this is:

$$\begin{matrix}{\vec{Y}}_{estimated} = [ \overline{D} ∘ {( {\overline{D}}^{T} ⊗ \overline{D} )}^{- 1} ] ∘ [ \frac{( {\overline{D}}^{T} ⊗ {\vec{Y}}_{in} )}{{\sum }_{j = 1}^{N} {W}^{⋒} ( j )} ] & ( 8 ) \\ {\vec{Y}}_{estimated} = [ \overline{C} ] ∘ [ \frac{\vec{K} ( {\vec{Y}}_{in} , \overline{D} )}{M} ] & ( 9 )\end{matrix}$$

Equation 6 can be optionally skipped, leaving W to be determined directly from equation 7.

In a second mode, the inferential mode, there are some sensors that are part of the observations comprising the matrix D, that are not included in the input observation Yᵢₙ, but are estimated by the model in response to the current input observation. In that case, the equations above become:

\vec{Y}_{estimated}=\vec{D}ₒᵤₜ∘\vec{W} (10)

$$\hat{{W}_{\to }} = {( {\overline{D}}_{in}^{T} ⊗ {\overline{D}}_{in} )}^{- 1} \cdot ( {\overline{D}}_{in}^{T} ⊗ {\vec{Y}}_{in} ) \qquad ( 11 )$$

where the D matrix has been separated into two matrices Dᵢₙ and Dₒᵤₜ, according to which rows are inputs and which rows are outputs, but column (observation) correspondence is maintained.In step 260 of FIG. 2, the estimates are compared to the actual values to produce residuals, which is the difference between each sensor actual value and estimated value. In step 270, alerts based on the residuals as described below can be generated, and further processing carried out to interpret the deviations as fault modes.

According to the preferred embodiment of the invention, two kinds of alerts are provided in response to the residuals. In a first kind of alert, called a residual threshold alert, a fixed threshold is placed on the absolute magnitude of the residual, and if the threshold is breached in any one observation, the alert is generated. In a second kind of alert, a sequential probability ratio test is used which accumulates deviations from one observation to the next, and generates an alert when the accumulation indicates a series distribution that is not centered on zero (i.e., the residual is not Gaussian noisy around zero, which would be expected if the model estimate and actual parameter were about the same).

According to the architecture of the present invention, the raw input values, the estimates, the residuals and the alerts are all made available to an incident diagnostics engine (ID Engine), which drives the generation of incidents to the watchlist. In the preferred embodiment, the ID engine executes within the runtime engine 110, but can also be implemented as a separate system networked with the modeling engine or the ECM database 115, and may even be remotely located and communicate over asynchronous messaging. A rules grammar is defined that allows the ID engine to mine the ECM database and generate incidents on that basis. That grammar will now be described. The ID Engine preferably operates at the Machine or Mode level of the Profile hierarchy and is capable of utilizing all sensors associated with that machine and all of the runtime analysis results generated the machines child modes and profiles.

Setup

A Rule Editor compiles user input entered through a user interface (GUI) that describes some operation to be performed on static programmed values and dynamic runtime values into an ID Logic object and saves the object to persistent storage.

Runtime

During runtime, a snapshot or batch of real-time data is acquired from sensors on the machine being monitored and tested against some set of profiles to yield the runtime analysis results, as has been described above.

The ID Engine processing

1. Inspect the Dynamic Operand List to determine if all necessary variables are present, if not, load the additional variables such as historical or Profile variables.

2. Load the Dynamic operands in the first level of Trigger/Rule Objects with sensor data.

3. Evaluate the Rule Objects.

4. If a Rule Object yields a true result and contains an action place the action on the Action stack.

5. When rules have been processed, process the instructions on the action stack.

The ID Engine operates on a set of Rule Objects that yield a Boolean result (true or false) indicating whether or not some condition or sets of conditions are true. If the result is true, then an Action may be generated or another rule invoked. Actions can cause any number of things to happen, such as creating incidents, logging incidents into the database and putting the monitored machine onto the WatchList, sending an e-mail, triggering adaptation, etc.

The Rule Object

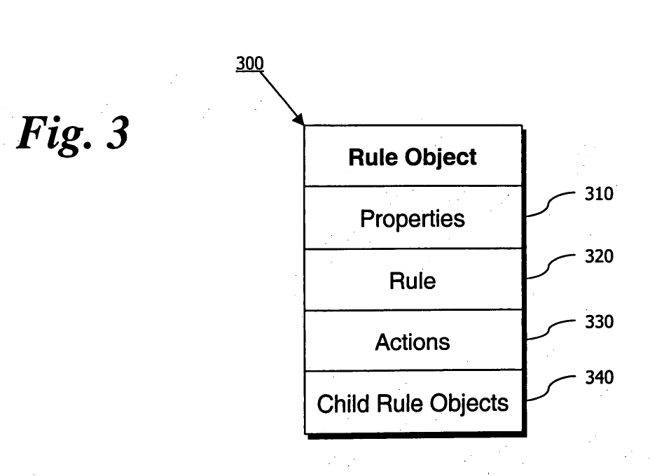

Turning to FIG. 3, the conceptual format of the Rule Object 300 can be seen as divided into four sections, Properties 310, the rule itself 320, actions 330 that may result from the rule, and child rule objects list 340.

Properties

ID Number—A non-zero value that uniquely identifies a Rule Object within a group that is associated with a specific equipment asset.

Active—enables processing of a Rule Object and its children.

Trigger—Identifies the Rule Object as being a trigger type, the start of a chain.

Root—In the case that a Trigger is not used; The Rule Object is identified as the start of a “chain”.

Rule

A rule is a collection of Clauses, which yield a true or false result. Internally, Clauses can perform numeric calculations however the final result must be Boolean (logical). Clauses results are either all logically ANDed to ORed to generate the Rule result. A rule may have as many Clauses as necessary.

Actions

Actions are a collection of instructions that are placed on the action stack if evaluation of the Rule Object yields a true result. Generally, only the last Rule Object in the “chain” to yield a true result will have their actions processed.

Child Rule Objects

The “Child Rule Objects” section contains a list of Rule Object Identifiers that are loaded and processed in the event that the current object yields a true result. Any number of Rule Objects can be “chained” together by this method. Processing continues from parent to child as long as the result is true and the number of Child Rule Object ID's is not zero.

Examples of evaluation of condition results within a rule according to the invention include single condition rules, ANDed rules and ORed rules.

Single condition rule:

If (condition) is true, then rule result is true

A rule with all ANDed Clauses:

If (condition) AND (condition) AND (condition) is true, then the rule result is true

A rule with all ORed Clauses:

If (condition) OR (condition) OR (condition) is true, then the result is true

Instructions

Instructions yield either numeric or Boolean results. However when processing incident logic, the highest or outermost instruction in a condition must yield a Boolean result so that the condition yields a Boolean result. An instruction performs some single operation such as are listed further below. Each instruction has an operation code that identifies some function; a fixed number of operands that it requires to perform its operation; and a numeric or Boolean Result. Example Clauses and instructions within a Rule would be:

Rule
{

Condition A:
{

Instruction B: Result_B = Smooth (Variable_Z Window size)
Instruction C: Result_C = GreaterThan ( Result_B, Threshold)

}
AND Condition B:
{

Instruction D: Result_D = GreaterThan
(Variable_X, Threshold)

}
AND Condition C:
{

Instruction E: Rule_Result = LessThan
( Variable_Y, Threshold)

}

} = Rule_Result;
If the Clauses in the above are all true, the rule yields a true result.
Rule
{

Condition A:
{

Instruction A: Result_A =
EqualTo( SPRT_Decision_Sensor_2)

Instruction B: Result_B =
MajorityRule( SPRT_Dec_Sensor_3, 10)
Instruction C: Rule_Result =
AND( Result_A, Result_B)

}

} = Rule_Result;

List of Rule Instructions (Operands are not Listed)

No Operation

Arithmetic

Add

Subtract

Multiply

Divide

Logical (Boolean)

And

Not

Equal To

Less Than

Greater Than

Less Than or Equal To

Greater Than or Equal To

Between

Pseudo Logical

Majority Rule

N Consecutive

Constant Value

Numeric

Smooth

SPRT Alarm Score

List of Action Instructions

No Operation

Database

Put Machine on WatchList and Log Incident to Database

Remove Machine from WatchList and Log to Database

Update Diagnostic Confidence measure

External Communications

Activate the Machine Incident Tag

Activate a specific Incident Tag

E-Mail, Pager notification

Output message to external system

Adaptation

Trigger Adaptation of model

Operand types

Operands include dynamic and static data that can be accessed by rules for logic.

Immediate Operand—A static value programmed into the rule itself.

Runtime Operand—Dynamic Observation vector oriented variables, one of each per time point.

IndicatedValue—Raw Input Data, modeled and non-modeled sensors

Actual—Actual values used in modeling, may have already been filtered.

Estimate

Residual

Smooth Residual—Moving window average

Pos Mean SPRT Decision

Neg Mean SPRT Decision

Pos Mean SPRT Index

Neg Mean SPRT Index

Std SPRT Index

Pos SPRT Score

Neg SPRT Score

Historical Operand—Data pulled from previous observations.

Actual

Residual

Pos Mean SPRT Index

Neg Mean SPRT Index

Pos Mean SPRT Decision

Neg Mean SPRT Decision

The above rules grammar can be executed in order to identify incidents, which are used to indicate failure modes and root causes, as known from expert domain knowledge. This way, residual-based patterns of deviations, as augmented by raw values and state values of the monitored system, can be turned into incidents that mean something to a human operator, someone who is responsible for reacting to the identification of the incident in the presentation layer. Also as described above, actions in software can be initiated by the incidents, such as pager or email notifications of responsible persons, or messaging to external systems, e.g., for creation of a maintenance work order.

Incident Objects

Object Hierarchy

Working up through the Incident/Diagnostic object containment hierarchy, operands contain data (such as thresholds, data sampling window sizes, etc.) as well as references to sensors; Instructions contain Operands; Rules contain Clauses and Instructions; Incident/Diagnostic Logic (IDLogic) objects contain a set of Rules. An IDLogic object can contain any number of rules. The set of rules contained within an IDLogic object may apply to a Machine or an operating Mode of that machine. There may be any number of IDLogic objects within the system of the present invention. An IDLogic object is identified by its location within the Machine/Profile hierarchy and its rules operate on data that is generated by the Profiles that exist below it. A path is used to specify the location of an IDLogic object in the same manner that a path is used to locate a Profile within the data hierarchy of the system.

An IDLogic object contains a hierarchy of rule relationships within itself. Each rule within an IDLogic object has a unique rule identifier or RuleID that is generated by the IDLogic object when the rule is created.

Unique Incident Identifier

Since an Incident is generated by the evaluation of a Rule, and an IDLogic object contains the Rule, that Incident can be uniquely identified by a combination of path to IDLogic object and the RuleID.

Incident Registration and Un-registration

If a Rule or set of rules can be written to register an Incident within the system, then a Rule or set of Rules can be written to un-register that Incident. A Machine is put on the WatchList because of one or more Rules generated the Incident(s) that put the Machine on watch. The un-registration of an Incident will not automatically remove a machine from the WatchList, but the automatic un-registration of all Incidents will automatically remove a Machine from the WatchList. If a Machine that is on the WatchList does not have Rules to un-register the Incident(s) that put it on watch, then the human user, through the use of the (web-based) user interface must manually remove the Machine from the WatchList.

The Rule that un-registers the incident must specify the ID of the Rule that caused the initial registration of the Incident. The rule that un-registers the Incident must belong to the same ID Logic object that registered the Incident.

Information Available Within an Incident Object

An Incident Object is a data structure that is generated by the ID Engine when a rule or chain of rules evaluates as true. The Incident Object contains information about the Incident. The Incident Object can be used to communicate the Incident to the Incident Log stored in the ECM database or to and external entity such as a maintenance work order system or parts inventory system. The recipient of the Incident Object may provide additional information that will be stored or used along with Incident object information. Fields of data that are preferably included in the Incident Object are:

Date/Time—The timestamp on the vector being processed that generated the Incident. This time stamp is derived from customer or user data by the Data Feed component. If a timestamp is not available, then one is generated by the Data Feed component at the time of acquisition by the Data Feed.

Path—Identifier of the IDLogic object.

RuleID—The unique identifier within the domain of the IDLogic object. The RuleID identifies the Rule that generated the Incident.

Rule Name—A short user programmable text name or description of rule.

Rule's Incident Message—A user programmable text message that is contained within the Rule and is passed into the Incident object when an incident is generated, which generally identifies the failure mode or root cause or anything else the user would like to call the incident.

Machine Name—A text name that is used to identify the machine with which the Incident is associated.

Auto-generated Incident Report—A text message that is automatically generated by the Incident/Diagnostic Engine consisting of:

The Clause as displayed on the UI (including sensor name) with real runtime values filled in at the time that the Incident was generated.

The chain of rule execution that led to this Rule/Incident.

Actions taken, such as IO tags that were asserted

Severity—A numerical value that is representative of the criticality of an Incident and is programmed by the user when the rule is edited or created.

Confidence value—Confidence is the probability that the identification of the Incident has been made correctly and is programmed by the user when the rule is edited, or can be determined algorithmically.

Action List—A list that indicates what action needs to be taken. For example, if the incident is to be registered, unregistered, some other action etc. In the case of un-registration, some fields may not be applicable.

Sensor Readings—A list of “Sensor Name” and “Value” pairs. If the sensor(s) that caused the Incident were used in a Profile, each of the analysis output variables such as Estimate, residual, alert decision etc, would be included.

Turning now to the Watchlist manager, the watchlist serves to focus the attention of the human expert on primarily those assets that warrant further investigation, as indicated by the generation of one or more new incidents. Generally, if an incident is new, or remains unacknowledged, it will cause the asset to be presented on the watchlist, which lists all such equipment across all equipment fleets monitored in the system for which the same condition of new or unacknowledged incidents is true. A graphical interface is preferably used wherein the user can click on the asset of interest on the watchlist to expand under the line of the asset the incident(s) which have triggered its presence on the watchlist. For incidents which can be fired repeatedly for repeated occurrences of matching patterns in the residuals, etc., that satisfy the incident rules, the count of incident firings can be displayed, as well as the time of the latest firing and the earliest firing. Each such incident can be further clicked to expand into a list of the sensors which are associated with the firing of the incident. Each such sensor can also be made clickable to load a separate window of graphical data showing a chart of the sensor values or residuals for that sensor.

Alternatively, the asset may be clicked to expand a view of all the sensors for which alerts are currently generated, either using the residual thresholds, raw value thresholds, or SPRT. Then each sensor may be clicked to show a chart of the raw data values, estimates, residuals, and alerts for that sensor.

In a preferred embodiment of the invention, the asset may be clicked to expand diagnostic incidents under it, and each incident, when clicked, opens a new window with a selection of multiple sensor charts that has been preconfigured to correspond to that kind of incident. Further, the incident watchlist can be configured to display only those assets within the data hierarchy that are within a category of interest. Therefore, there can be multiple watchlists, one for each of a plurality of categories, e.g., fleets, of equipment being monitored. This further enhances the efficiency of the human operator in focusing on incidents within a certain class of equipment, one class at a time, or allowing security to be employed such that certain human users only have authorization for the watchlists for certain categories of equipment.

Turning now to monitoring particularly of aircraft turbines/engines, the present invention can be set up with a hierarchy of categories corresponding to fleets of aircraft by airframe and engine type, and by carrier. This is useful because it is common for air carriers to have specialists for each airframe-engine combination, and therefore each specialist can focus on a particular combination that is their specialty without being distracted by other watchlist incidents that are not their responsibility.

It will be appreciated by those skilled in the art, that modifications to the foregoing preferred embodiments may be made in various aspects. Other variations clearly would also work, and are within the scope and spirit of the invention. The present invention is set forth with particularity in the appended claims. It is deemed that the spirit and scope of that invention encompasses such modifications and alterations to the preferred embodiment as would be apparent to one of ordinary skill in the art and familiar with the teachings of the present application.

What is claimed is:

1. An asset fleet health monitoring system, comprising:
a sensor data feed module for providing multivariate sensor data from a plurality of fleet assets;
a database for storing empirical models of assets in the fleet;
an estimation engine disposed to generate estimated sensor values and residuals in response to receiving from the data feed an observation of multivariate sensor data for an asset in the fleet, using a corresponding empirical model for the asset stored in said database;
an incident diagnostics engine module responsive at least to said residuals to determine whether an incident should be registered for said asset; and
a graphical interface module having a hierarchical fleet view of the health status of all assets and an exception-based view of all assets having registered incidents.

2. A system according to claim 1, wherein said estimation engine generates estimated sensor values according to a nonparametric kernel-based method.

3. A system according to claim 2, wherein said estimation engine generates estimated sensor values according to a similarity-based modeling method.

4. A system according to claim 3, wherein said incident diagnostics engine comprises rule objects having rules and actions, and executes rules against at least said residuals to determine whether an incident should be registered for said asset.

5. A system according to claim 4, wherein said incident diagnostics engine has an action stack, and when a rule of a rule object evaluates to a particular condition, an action of the rule object is added to the action stack for execution, and where possible actions include registering an incident for the asset.

6. A system according to claim 5, wherein an action of a rule object is to activate another rule object.

7. A system according to claim 1, further comprising a model creation module for processing historic reference data for an asset to generate a model f or the asset and storing it in said database.

8. A system according to claim 7, wherein said model creation module is functional to copy reference data and a model for an asset stored in said database for offline model modification, and further functional to copy a modified model into said database and activate it for runtime processing of incoming observations corresponding to the asset.

9. A system according to claim 3, wherein said database stores said empirical models in a hierarchical format corresponding to the hierarchical fleet view of said graphical user interface module.

10. A system according to claim 9, wherein the hierarchical format includes a hierarchy level corresponding to a collection of assets, a hierarchy level corresponding to individual assets, and a hierarchy level corresponding to modes of operation of individual assets.

11. A system according to claim 3, wherein said graphical user interface module has an exception-based view of a subset of assets in the fleet having registered incidents.

12. A system according to claim 11, wherein any exception-based view of assets in the fleet having registered incidents is functional to list registered incidents for a given asset under the asset in the view, upon a user action indicating selection of the asset for listing of its incidents.

13. A system according to claim 12, wherein said graphical user interface module is disposed to provide its views in a format viewable in a web browser, and an asset on any exception-based view is hyperlinked to activate a listing of its registered incidents under it in the view.
